(19) United States
(12) Patent Application Publication
(10) Pub. No.: US 2026/0322240 A1
(43) Pub. Date: Oct. 15, 2026

(54) ENERGY BALANCING CONTROL OF Y-CONNECTED CASCADED H-BRIDGE CONVERTER

(71) Applicant: Delta Electronics India Pvt Ltd., Haryana (IN)

(72) Inventors: Debdeep SAMAJDAR, Karnataka (IN); Subhrasankha GHOSH, Karnataka (IN); Shashidhar MATHAPATI, Karnataka (IN); Vivek BHAT, Karnataka (IN)

(21) Appl. No.: 19/645,280

(22) Filed: Apr. 12, 2026

(30) Foreign Application Priority Data
Apr. 11, 2025 (IN) 202511035697

(51) Int. Cl. H02M 1/00

(52) U.S. Cl. CPC H02M 1/007; H02M 1/0009; H02M 1/0083

(57) ABSTRACT

An energy balancing control method employing an α-β stationary reference frame-based decoupled energy balancing control to a Y-connected cascaded h-bridge converter is disclosed. The method includes calculation of energy vectors, calculation of inter-phase controllers, and calculations of normalized current. The method derives a closed-loop control technique based on actual energies calculated from capacitor voltages of sub-modules of the Y-connected cascaded h-bridge converter and eliminates the need for feed-forward calculations or complex inverse-mapping procedures. Moreover, the closed-loop technique considers errors committed due to parameter variation or unmodeled dynamics.

### CROSS-REFERENCE TO RELATED APPLICATION

The present application claims priority to Indian Patent Application number 202511035697, filed with Indian Patent Office on Apr. 11, 2025 and entitled “ENERGY BALANCING CONTROL OF Y-CONNECTED CASCADED H-BRIDGE CONVERTER”. The disclosure of the aforementioned application is hereby incorporated by reference in its entirety.

### TECHNICAL FIELD

The present disclosure relates to α-β stationary reference frame-based energy balancing control techniques, and more particularly the present disclosure relates to energy balancing control of Y-connected cascaded H-bridge converter.

### BACKGROUND

Multilevel converters are gaining popularity in high-voltage, high-power applications primarily due to their reliability, scalability, and superior output voltage quality. The Y-connected full-bridge (FB) sub-module (SM) based multilevel converter, popularly known as the cascaded H-bridge (CHB) converter, is a very popular choice for STATic COMpensator (STATCOM) applications. The energy balancing of the SM capacitors is generally performed in a cluster-control architecture. The total energy of the three-phase is commonly controlled using the active component of the grid current. For STATCOM applications, the active current magnitude is significantly lower. However, this total energy controller is not sufficient to keep the individual phase energies regulated at their stipulated values. This phenomenon becomes more pronounced under unbalanced grid voltage and/or grid current operations. An inter-phase (IP) energy regulation is commonly performed using a zero-sequence voltage injection.

Thus, there is a need to achieve energy balancing control of Y-connected/star-connected cascaded H-bridge converter, especially a need to achieve decoupled energy balancing control of Y-connected/star-connected cascaded H-bridge converter.

### SUMMARY

This summary is provided to introduce concepts of the present disclosure. This summary is neither intended to identify essential features of the present disclosure nor is it intended for use in determining or limiting the scope of the present disclosure.

In one aspect, the present disclosure provides a method for α-β stationary reference frame-based decoupled energy balancing control of a three-phase Y-connected cascaded H-bridge converter with direct zero-sequence voltage generation.

The method includes the steps of: converting phase instantaneous energy values into orthogonal energy components, phase grid current into orthogonal instantaneous current measurement components, and phase grid power into orthogonal instantaneous power measurement components by applying a stationary reference frame transformation; deriving unit current vectors from the orthogonal instantaneous current measurement components; calculating fundamental cycle time-averaged orthogonal energy components from the orthogonal energy components; comparing the fundamental cycle time averaged orthogonal energy components with predetermined orthogonal energy reference values, wherein the predetermined orthogonal energy reference values are classified as a α axis orthogonal energy reference value and a β axis orthogonal energy reference value; generating a corresponding α-axis error signal and a corresponding β-axis error signal; generating a first control signal from the corresponding α-axis error signal and the unit current vector; generating a second control signal from the corresponding β-axis error signal and the unit current vectors; and generating a common-mode voltage signal by combining the first control signal and the second control signal.

Additionally, the method further includes: calculating phase instantaneous additional energy contribution values from the common-mode voltage signal and the orthogonal instantaneous current measurement components; generating zero-sequence energy values from the orthogonal instantaneous power measurement components and phase additional energy contribution values; and comparing the zero-sequence energy values with predetermined total energy reference values derived from nominal operating condition and forming a closed-loop control to balance the cascaded H-bridge converter.

Further, the α axis orthogonal energy reference value and the β axis orthogonal energy reference value are intentionally set to zero to eliminate inter phase energy imbalance.

Furthermore, in the step of converting the phase instantaneous energy values into the orthogonal energy components by applying the stationary reference frame transformation, the orthogonal energy components are represented as:

$$[ \begin{matrix}{e}_{α} \\ {e}_{β} \\ {e}_{0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{e}_{a} \\ {e}_{b} \\ {e}_{c}\end{matrix} ]$$

where (eₐ, e_{b}, e_{c}) represents the phase instantaneous energy values and (eₐ, e_{b}, e_{c}) represents the orthogonal energy components.

Furthermore, in the step of converting the phase grid power into the orthogonal instantaneous power measurement components by applying the stationary reference frame transformation, the orthogonal instantaneous power measurement components are represented as:

$$[ \begin{matrix}{p}_{g α} \\ {p}_{g β} \\ {p}_{g 0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{p}_{ga} \\ {p}_{gb} \\ {p}_{gc}\end{matrix} ] = [ \begin{matrix}\frac{2}{3} {v}_{ga} {i}_{ga} - \frac{1}{3} {v}_{gb} {i}_{gb} - \frac{1}{3} {v}_{gc} {i}_{gc} \\ \frac{1}{\sqrt{3}} {v}_{gb} {i}_{gb} - \frac{1}{\sqrt{3}} {v}_{gc} {i}_{gc} \\ \frac{1}{3} {v}_{ga} {i}_{ga} + \frac{1}{3} {v}_{gb} {i}_{gb} + \frac{1}{3} {v}_{gc} {i}_{gc}\end{matrix} ] = [ \begin{matrix}\frac{1}{2} ( {v}_{g α} {i}_{g α} - {v}_{g β} {i}_{g β} ) \\ - \frac{1}{2} ( {v}_{g α} {i}_{g β} + {v}_{g β} {i}_{g α} ) \\ \frac{1}{2} ( {v}_{g α} {i}_{g α} + {v}_{g β} {i}_{g β} )\end{matrix} ] ,$$

where (p_{gα}, p_{gβ}, p_{g0}) represents the orthogonal instantaneous power measurement components, (p_{gj}) represents phase grid power, (v_{gj}) represents phase grid voltage, (i_{gj}) represents phase grid current, wherein ∀j∈{a, b, c}, (v_{gα}, v_{gβ}) represents the orthogonal instantaneous voltage measurement components, and (i_{gα}, i_{gβ}) represents the orthogonal instantaneous current measurement components.

In one embodiment, the stationary reference frame transformation is Clarke Transformation.

In one embodiment, the unit current vectors are derived by normalizing the orthogonal instantaneous current measurement components.

Further, in the step of calculating the fundamental cycle time-averaged orthogonal energy components from the orthogonal energy components, the fundamental cycle time-averaged orthogonal energy components are represented as:

$$\begin{matrix}{E}_{α f} = \frac{1}{T} {\int }_{0}^{T} {e}_{α} dt ; \\ {E}_{β f} = \frac{1}{T} {\int }_{0}^{T} {e}_{β} dt ,\end{matrix}$$

where (E_{αf}, E_{βf}) represents the fundamental cycle time-averaged orthogonal energy components and (e_{α}, e_{β}, e₀) represents the orthogonal energy components.

Furthermore, the step of generating the first control signal, the first control signal is generated by processing the corresponding α-axis error signal and the unit current vector through closed-loop proportional-integral (PI) controllers and represented as:

v_{com,α}=k_{α}\hat{ι}_{gα};
where (v_{com,α}) represents the first control signal, (k_{α}) represents the closed-loop proportional-integral (PI) controller output derived from the corresponding α-axis error signal, (\hat{ι}_{gα}) represents the unit current vector corresponding to α-axis.

In one embodiment, the closed-loop proportional-integral (PI) controller output (k_{α}) derived from the corresponding α-axis error signal is represented as:

$${k}_{α} = {K}_{p} ( {E}_{α}^{*} - {E}_{α} ) + {K}_{i} {\int }_{0}^{T} ( {E}_{α}^{*} - {E}_{α} ) dt ,$$

where (E_{α}) represents the zero-sequence energy values and

$$( {E}_{α}^{*} )$$

represents the α axis orthogonal energy reference value.

Furthermore, in the step of generating the second control signal, the second control signal is generated by processing the corresponding β-axis error signal and the unit current vector through closed-loop proportional-integral (PI) controllers and represented as:

v_{com,β}=k_{β}\hat{ι}_{gβ},
where (v_{com,β}) represents the second control signal, (k_{β}) represents the closed-loop proportional-integral (PI) controller output derived from the corresponding β-axis error signal, and (\hat{ι}_{gβ}) represents the unit current vector corresponding to β-axis.

In one embodiment, the closed-loop proportional-integral (PI) controller output (k_{β}) derived from the corresponding β-axis error signal is represented as:

$${k}_{β} = {K}_{p} ( {E}_{β}^{*} - {E}_{β} ) + {K}_{i} {\int }_{0}^{T} ( {E}_{β}^{*} - {E}_{β} ) dt ,$$

where (E_{β}) represents the zero-sequence energy values and

$$( {E}_{β}^{*} )$$

represents the β axis orthogonal energy reference value.

Furthermore, in the step of calculating phase instantaneous additional energy contribution values, phase instantaneous additional energy contribution values are represented as:

$$\begin{matrix}Δ {E}_{com , α} = {\int }_{0}^{T} {v}_{com} {i}_{g α} dt ; \\ Δ {E}_{com , β} = {\int }_{0}^{T} {v}_{com} {i}_{g β} dt ,\end{matrix}$$

where (ΔE_{com,α}, ΔE_{com,β}) represents the phase instantaneous additional energy contribution values, (v_{com}) represents the common-mode voltage signal and (i_{gα}, i_{gβ}) represents the orthogonal instantaneous current measurement components.

Furthermore, in the step of generating the zero-sequence energy values, the zero-sequence energy values are represented as:

$$\begin{matrix}{E}_{a} = {\int }_{0}^{T} {p}_{g α} dt + {\int }_{0}^{T} {v}_{com} {i}_{g α} dt = {\int }_{0}^{T} {p}_{gα} dt + Δ {E}_{com , α} ; \\ {E}_{β} = {\int }_{0}^{T} {p}_{g β} dt + {\int }_{0}^{T} {v}_{com} {i}_{g β} dt = {\int }_{0}^{T} {p}_{g β} dt + Δ {E}_{com , β} ,\end{matrix}$$

where (E_{α}, E_{β}) represents the zero-sequence energy values, (p_{gα}, p_{gβ}) represents the orthogonal instantaneous power measurement components, (ΔE_{com,α}, ΔE_{com,β}) represents the phase instantaneous additional energy contribution values, (v_{com}) represents the common-mode voltage signal and (i_{gα}, i_{gβ}) represents the orthogonal instantaneous current measurement components.

In one aspect, the present disclosure provides a system for α-β stationary reference frame-based decoupled energy balancing control of a cascaded H-bridge converter with direct zero-sequence voltage generation. In an embodiment, the cascaded H-bridge converter is a Y-connected/star-connected cascaded H-bridge converter. The system includes a memory storing executable control instructions; and a processor operably coupled to the three-phase Y-connected cascaded H bridge converter and configured, upon execution of the control instructions, to: receive measured phase currents, grid voltages, and sub module capacitor voltages of the three-phase Y-connected cascaded H bridge converter; and perform energy balancing control by executing the method, wherein the energy balancing control is implemented through modification of control software executed by the processor capable of being without requiring additional hardware components.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF DRAWINGS

The detailed description is described with reference to the accompanying figures.

FIG. 1 illustrates an overall control block diagram for decoupled energy balancing control of Y-connected cascaded H-bridge converter in accordance with an embodiment of the present disclosure.

FIG. 2 illustrates energy vectors' calculations in accordance with an embodiment of the present disclosure.

FIG. 3 illustrates current unit vector calculations in accordance with an embodiment of the present disclosure.

FIG. 4 illustrates inter-phase energy balancing controllers in α-β domain in accordance with an embodiment of the present disclosure.

FIG. 5 illustrates closed-loop controllers and plant models in accordance with an embodiment of the present disclosure.

FIG. 6 illustrates a flowchart of the method for balancing control of Y-connected cascaded H-bridge converter in accordance with an embodiment of the present disclosure.

FIG. 7 illustrates a plot of three-phase currents vs time in accordance with an embodiment of the present disclosure.

FIG. 8 illustrates a plot of three-phase average SM capacitor voltages vs time in accordance with an embodiment of the present disclosure.

FIG. 9 illustrates a plot of per-unit common-mode voltage vs time in accordance with an embodiment of the present disclosure.

FIG. 10 illustrates a system level architecture for decoupled energy balancing control of Y-connected cascaded H-bridge converter in accordance with an embodiment of the present disclosure.

It should be appreciated by those skilled in the art that any block diagrams herein represent conceptual views of illustrative methods embodying the principles of the present disclosure. Similarly, it will be appreciated that any flow charts, flow diagrams, and the like represent various processes which may be substantially represented in computer readable medium and so executed by a computer or processor, whether or not such computer or processor is explicitly shown.

### DESCRIPTION OF EMBODIMENTS

The various embodiments of the present disclosure describe α-β stationary reference frame-based decoupled energy balancing control of Y-connected cascaded H-bridge converter.

In the following description, for the purpose of explanation, specific details are set forth in order to provide an understanding of the present disclosure. It will be apparent, however, to one skilled in the art that the present disclosure may be practiced without these details. One skilled in art will recognize that embodiments of the present disclosure, some of which are described below, may be incorporated into a number of systems.

However, the systems and methods are not limited to the specific embodiments described herein. Further, the structures and devices shown in the figures are illustrative of exemplary embodiments of the present disclosure and are meant to avoid obscuring of the present disclosure.

It should be noted that the description merely illustrates the principles of the present disclosure. It will thus be appreciated that those skilled in art will be able to devise various arrangements that, although not explicitly described herein, embody the principles of the present disclosure. Furthermore, all examples recited herein are principally intended expressly to be only for explanatory purposes to help the reader in understanding the principles of the disclosure and the concepts contributed by the inventor to furthering art and are to be construed as being without limitation to such specifically recited examples and conditions. Moreover, all statements herein reciting principles, aspects, and embodiments of the disclosure, as well as specific examples thereof, are intended to encompass equivalents thereof.

In one aspect, one embodiment of the present disclosure provides a method for α-β stationary reference frame-based decoupled energy balancing control of a cascaded H-bridge converter with direct zero-sequence voltage generation. In an embodiment, the cascaded H-bridge converter is a Y-connected/star-connected cascaded H-bridge converter.

In the field of high-voltage, high-power applications, multilevel converters, particularly Y-connected cascaded H-bridge converters, are widely utilized due to their scalability, reliability, and superior output voltage quality. These converters are commonly employed in STATCOM systems for reactive power compensation and voltage regulation. However, maintaining balanced energy distribution among the sub-module capacitors in such converters presents a significant challenge, especially under unbalanced grid voltage and current conditions. The inability to regulate individual phase energies effectively can lead to system instability, reduced performance, and potential damage to the converter components.

The present system and method provide a solution to these challenges by introducing a decoupled energy balancing control methodology for Y-connected cascaded H-bridge converters. The approach leverages the α-β stationary reference frame to enable independent regulation of individual phase energies while maintaining overall energy balance. By employing direct zero-sequence voltage generation from instantaneous current values and utilizing actual phase energies derived from sub-module capacitor voltages, the present method eliminates the need for computation-intensive feed-forward calculations, symmetrical component extraction, and inverse mapping procedures. This simplified control architecture promotes stable operation under unbalanced conditions, enhances system reliability, and reduces computational burden, making the approach particularly suitable for demanding STATCOM applications.

Further, the present system directly generates zero-sequence voltage references from instantaneous current values, bypassing the dependency on phase-locked loop (PLL) angle information and improving reliability during steep grid voltage transients. Furthermore, the described system implements closed-loop control techniques based on actual phase energies derived from sub-module capacitor voltages, ensuring robustness against parameter variations and unmodeled dynamics. The present system significantly reduces implementation complexity while maintaining stable and convergent capacitor voltages under unbalanced operating conditions, as demonstrated by simulation results.

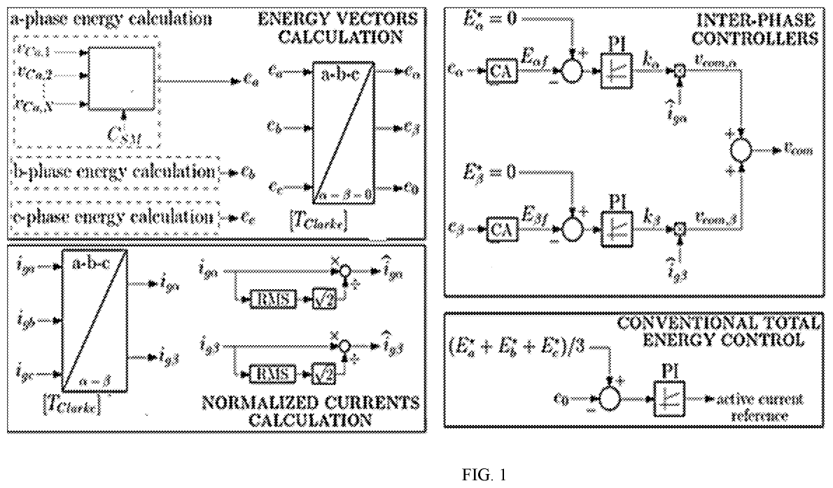

Now referring to FIG. 1, an overall control block diagram for implementing the present method for α-β stationary reference frame-based decoupled energy balancing control of Y-connected cascaded H-bridge converter in accordance with an embodiment of the present disclosure is illustrated. The overall control method includes calculation of energy vectors, implementation of inter-phase controllers, and calculations of normalized current.

In an embodiment, in a multi-phase system, the j^{th} phase grid voltage and grid current are denoted by v_{gj} and i_{gj}, respectively where j is any one of the multi phrases of power supply, in the embodiment, the multi-phase system is a three-phase system, i.e., a-phase, b-phase, or c-phase. The total three-phase power can be calculated from the following equation (1):

p_{3ø}=Σ_{j=a,b,c}v_{gj}×i_{gj} (1).

During steady-state operation, the total three-phase active power for a STATCOM can be assumed zero when ignoring the negligible converter losses.

Firstly, a plurality of sub-modules (SMs) are connected in a cascaded H-bridge converter. Now, if instantaneous energy values of the j^{th} phase energies (denoted by eⱼ) are calculated from capacitor voltages of N SMs with capacitance (C_{SM}), the instantaneous value of SM capacitor voltage of the i^{th} SM of the j^{th} phase is represented by (v_{cj,i}) [∀j∈{a, b, c} & i=1(1)N]. This derives from the following equation (2):

$${e}_{j} = {\sum }_{i = 1}^{N} \frac{1}{2} {C}_{SM} {v}_{cj , i}^{2} ∀ j ∈ \{ a , b , c \} . \qquad ( 2 )$$

The values from (a-b-c) domain are converted to their corresponding orthogonal components. In an embodiment, the orthogonal energy components are represented in a (α-β-0) domain. The (α-β-0) stationary reference frame is used to convert the calculated values from (a-b-c) domain into orthogonal energy components. In one embodiment, the Clarke transformation matrix for conversion from (a-b-c) to (α-β-0) is applied as given in equation (3).

$$[ \begin{matrix}{x}_{α} \\ {x}_{β} \\ {x}_{0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{x}_{a} \\ {x}_{b} \\ {x}_{c}\end{matrix} ] = [ {T}_{Clarke} ] [ \begin{matrix}{x}_{a} \\ {x}_{b} \\ {x}_{c}\end{matrix} ] . \qquad ( 3 )$$

The calculated phase instantaneous energy values (eₐ, e_{b}, e_{c}) are converted into orthogonal energy components to control the unbalanced phase energies or powers as well as the total three-phase energy. In the embodiment, the calculated phase instantaneous energy values (eₐ, e_{b}, e_{c}) are converted into orthogonal energy components to control the unbalanced phase energies or powers as well as the total three-phase energy. The phase grid current (i_{gj}) and the phase grid power (p_{gj}) are also converted into orthogonal instantaneous current measurement components (i_{gα}, i_{gβ}) and orthogonal instantaneous power measurement components (p_{gα}, p_{gβ}, p_{g0}) respectively by applying the stationary reference frame transformation.

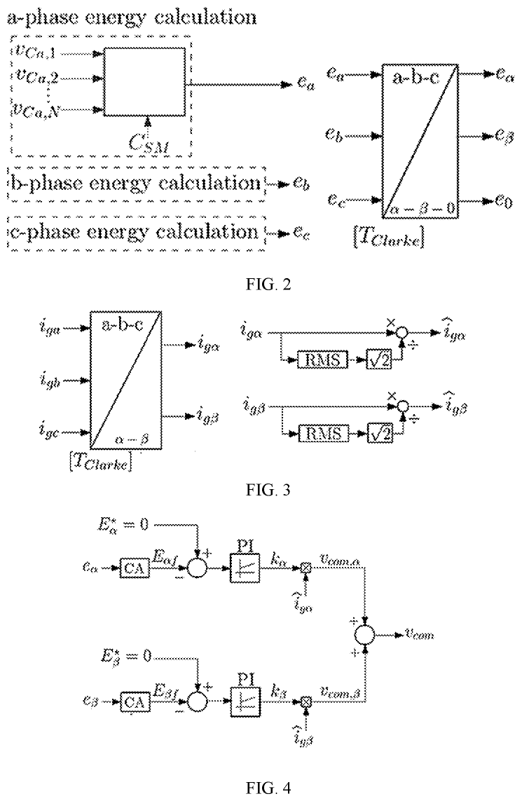

Referring to FIG. 2, a block diagram for the complete energy vector calculations is illustrated. The expression given below in equation (4) is implemented for converting the phase instantaneous energy values (eₐ, e_{b}, e_{c}) into orthogonal energy components (e_{α}, e_{β}, e₀). Further, common-mode energy e₀ is used to control the total energy of the three-phase system in the conventional way.

$$[ \begin{matrix}{e}_{α} \\ {e}_{β} \\ {e}_{0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{e}_{a} \\ {e}_{b} \\ {e}_{c}\end{matrix} ] \qquad ( 4 )$$

where (eₐ, e_{b}, e_{c}) represents the phase instantaneous energy values and (e_{α}, e_{β}, e₀) represents the orthogonal energy components.

The orthogonal instantaneous power measurement components (p_{gα}, p_{gβ}, p_{g0}) can be calculated by equation (5) as below:

$$[ \begin{matrix}{p}_{g α} \\ {p}_{g β} \\ {p}_{g 0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{p}_{ga} \\ {p}_{gb} \\ {p}_{gc}\end{matrix} ] = [ \begin{matrix}\frac{2}{3} {v}_{ga} {i}_{ga} - \frac{1}{3} {v}_{gb} {i}_{gb} - \frac{1}{3} {v}_{gc} {i}_{gc} \\ \frac{1}{\sqrt{3}} {v}_{gb} {i}_{gb} - \frac{1}{\sqrt{3}} {v}_{gc} {i}_{gc} \\ \frac{1}{3} {v}_{ga} {i}_{ga} + \frac{1}{3} {v}_{gb} {i}_{gb} + \frac{1}{3} {v}_{gc} {i}_{gc}\end{matrix} ] = [ \begin{matrix}\frac{1}{2} ( {v}_{g α} {i}_{g α} - {v}_{g β} {i}_{g β} ) \\ - \frac{1}{2} ( {v}_{g α} {i}_{g β} + {v}_{g β} {i}_{g α} ) \\ \frac{1}{2} ( {v}_{g α} {i}_{g α} + {v}_{g β} {i}_{g β} )\end{matrix} ] \qquad ( 5 )$$

where (p_{gα}, p_{gβ}, p_{g0}) represents the orthogonal instantaneous power measurement components, (p_{gj}) represents each phase grid power, (v_{gj}) represents each phase grid voltage, (i_{gj}) represents each phase grid current, wherein ∀j∈{a, b, c}, (v_{gα}, v_{gβ}) represents the orthogonal instantaneous voltage measurement components, and (i_{gα}, i_{gβ}) represents the orthogonal instantaneous current measurement components.

The unit current vectors (\hat{ι}_{gα}, \hat{ι}_{gβ}) in α-β domain are generated as illustrated in FIG. 3. Further, the instantaneous current measurements (i_{gα}, i_{gβ}) are normalized to derive a unit current vectors (\hat{ι}_{gα}, \hat{ι}_{gβ}).

The fundamental cycle time-averaged orthogonal energy components (E_{αf}, E_{βf}) are calculated from the orthogonal energy components (e_{α}, e_{β}, e₀) using the below equations (6a) and (6b):

$${E}_{α f} = \frac{1}{T} {\int }_{0}^{T} {e}_{α} dt ; \qquad ( 6 a )$$

$${E}_{β f} = \frac{1}{T} {\int }_{0}^{T} {e}_{β} dt , \qquad ( 6 b )$$

where (E_{αf}, E_{βf}) represents the fundamental cycle time-averaged orthogonal energy components and (e_{α}, e_{β}, e₀) represents the orthogonal energy components.

Under balanced operating conditions, the α-β components of time-averaged energies or powers are zero. However, during the unbalanced condition of STATCOM, the time-averaged values of per-phase powers have a non-zero component in the α-β domain. Hence, in the embodiment, it may apply two controllers in the α-β domain to be sufficient to eliminate the phase energy imbalances. The three-phase total energy of the system can be regulated using the 0-axis component. These facilitate effective decoupling between the different sets of cluster controllers, i.e., inter-phase and total energy control.

Further, the fundamental cycle time-averaged orthogonal energy components (E_{αf}, E_{βf}) are compared with predetermined orthogonal energy reference values, wherein the predetermined orthogonal energy reference values are classified as an α-axis orthogonal energy reference value

$$( {E}_{α}^{*} )$$

and a β-axis orthogonal energy reference value

$$( {E}_{β}^{*} ) .$$

Based upon the α-axis orthogonal energy reference value

$$( {E}_{α}^{*} )$$

and the β-axis orthogonal energy reference value

$$( {E}_{β}^{*} ) ,$$

a corresponding α-axis error signal and a corresponding β-axis error signal are generated. Further, the α-axis error signal and the β-axis error signal are fed to two closed-loop controllers to generate (k_{α}) and (k_{β}) represented as the controller outputs derived from the corresponding α-axis error signal and the corresponding β-axis error signal respectively. As α and β axes are orthogonal, the common mode-voltage (v_{com}) can be expressed in terms of two orthogonal components first common mode-voltage signal (v_{com,α}) and a second common mode-voltage (v_{com,β}) respectively as defined in equations (7a) to (7c) below:

v_{com}=v_{com,α}+v_{com,β} (7a);

v_{com,α}=k_{α}\hat{ι}_{gα} (7b);

v_{com,β}=k_{β}\hat{ι}_{gβ} (7c),
where (v_{com,α}) represents the first control signal, (k_{α}) represents the controller output derived from the corresponding α-axis error signal, (\hat{ι}_{gα}) represents the unit current vector corresponding to α-axis, (v_{com,β}) represents the second control signal, (k_{β}) represents the controller output derived from the corresponding β-axis error signal, and (\hat{ι}_{gβ}) represents the unit current vector corresponding to β-axis.

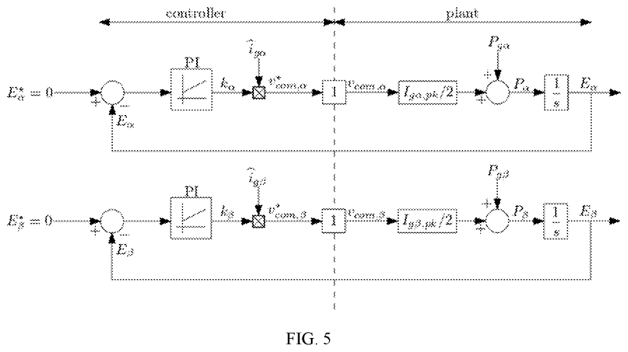

Two separate closed-loop controllers are used to generate the k_{α} and k_{β}, as illustrated in FIG. 4. The closed-loop controller outputs for the inter-phase controllers are derived using two proportional-integral (PI) controllers. The expressions for α and β axes PI controllers are given below in equations (8a) and (8b):

$${k}_{α} = {K}_{p} ( {E}_{α}^{*} - {E}_{α} ) + {K}_{i} {\int }_{0}^{T} ( {E}_{α}^{*} - {E}_{α} ) dt ; \qquad ( 8 a )$$

$${k}_{β} = {K}_{p} ( {E}_{β}^{*} - {E}_{β} ) + {K}_{i} {\int }_{0}^{T} ( {E}_{β}^{*} - {E}_{β} ) dt , \qquad ( 8 b )$$

Here,

$${E}_{α}^{*} = {E}_{β}^{*} = 0$$

are the references for the α and β axes energies. Thus, the predetermined orthogonal energy reference values

$$( {E}_{α}^{*} , {E}_{β}^{*} )$$

are set to zero to enforce energy balance under nominal operating condition.

Based upon equations (7a), (7b), (7c), (8a) and (8b), the common mode-voltage (v_{com}) can also be defined as below:

$${v}_{c om , α} = [ {K}_{p} ( {E}_{α}^{*} - {E}_{α} ) + {K}_{i} {\int }_{0}^{T} ( {E}_{α}^{*} - {E}_{α} ) d t ] \times {\hat{ι}}_{g α} ;$$

$${v}_{c o m , β} = [ {K}_{p} ( {E}_{β}^{*} - {E}_{β} ) + {K}_{i} {\int }_{0}^{T} ( {E}_{β}^{*} - {E}_{β} ) d t ] \times {\hat{ι}}_{g β} .$$

For unbalanced operating conditions, the orthogonal instantaneous power measurement components P_{gα}=P_{gβ}=0 cannot be ensured. The common practice is to inject common-mode voltages into the phase voltage references to make the time-averaged powers equal to zero. These modified powers can be used to calculate the magnitude and phase of the common-mode voltage required for inter-phase energy balancing. However, these inverse-mapping computations generally require high implementation effort for filtering, sequence component extraction etc. The generation of common-mode voltage references directly from the instantaneous current magnitudes may eliminate the need for complex inverse mapping. In addition to that, the unbalance in phase-powers results in unbalance in energies in α-β domain. As a result, the measured energies from the SM capacitor voltages may be directly used in the present method of the embodiment to generate the common-mode voltage without employing any computation-intensive feed-forward calculations. Moreover, the calculated common-mode energy (0-axis) will be used for the conventional total energy controller.

The common-mode voltage is represented as v_{com}, therefore, the converter voltages, which are denoted by vᵢₐ, v_{ib}, v_{ic}, respectively, after common-mode voltage addition are as described in equations (9a) to (9c):

vᵢₐ=v_{ga}+v_{com} (9a);

v_{ib}=v_{gb}+v_{com} (9b);

v_{ic}=v_{gc}+v_{com} (9c).

The fundamental-cycle average energies, i.e., cycle with time period T, for the three-phases denoted by Eₐ, E_{b}, E_{c}, respectively after common-mode voltage addition are given below in equations (10a)-(10c):

$${E}_{a} = {\int }_{0}^{T} {v}_{ia} {i}_{g a} d t = {\int }_{0}^{T} {v}_{g a} {i}_{g a} d t + {\int }_{0}^{T} {v}_{c o m} {i}_{g a} d t = {\int }_{0}^{T} {v}_{g a} {i}_{g a} dt + Δ {E}_{c o m , a} ; \qquad ( 10 a )$$

$${E}_{b} = {\int }_{0}^{T} {v}_{i b} {i}_{g b} d t = {\int }_{0}^{T} {v}_{g b} {i}_{g b} d t + {\int }_{0}^{T} {v}_{c o m} {i}_{g b} d t = {\int }_{0}^{T} {v}_{g b} {i}_{g b} dt + Δ {E}_{c o m , b} ; \qquad ( 10 b )$$

$${E}_{c} = {\int }_{0}^{T} {v}_{ic} {i}_{g c} d t = {\int }_{0}^{T} {v}_{g c} {i}_{g c} d t + {\int }_{0}^{T} {v}_{c o m} {i}_{g c} d t = {\int }_{0}^{T} {v}_{g c} {i}_{g c} dt + Δ {E}_{c o m , c} . \qquad ( 10 c )$$

Here, ΔE_{com,a}, ΔE_{com,b}, and ΔE_{com,c} denote the instantaneous additional energy contribution values due to the common-mode voltage for different phases. In the embodiment, the reference value of the phase energies is maintained at

$${E}_{a}^{*} = {E}_{b}^{*} = {E}_{c}^{*} = {E}^{*} ( let ) .$$

Applying Clarke's transformation of equation (3) on the three-phase energies, the below equations (11a) and (11b) can be determined using equation (5).

$${E}_{α} = {\int }_{0}^{T} {p}_{g α} d t + {\int }_{0}^{T} {v}_{c o m} {i}_{g α} d t = {\int }_{0}^{T} {p}_{g α} d t + Δ {E}_{c om , α} , \qquad ( 11 a )$$

$$where Δ {E}_{c om , α} = {\int }_{0}^{T} {v}_{c o m} {i}_{g α} dt ;$$

$${E}_{β} = {\int }_{0}^{T} {p}_{g β} d t + {\int }_{0}^{T} {v}_{c o m} {i}_{g β} d t = {\int }_{0}^{T} {p}_{g β} d t + Δ {E}_{c o m , β} , \qquad ( 11 b )$$

$$where Δ {E}_{c o m , β} = {\int }_{0}^{T} {v}_{c o m} {i}_{g β} d t .$$

ΔE_{com,α} and ΔE_{com,β} denote the instantaneous additional energy contribution values due to the common-mode voltage in α and β axes respectively, and (E_{α}, E_{β}) represents the zero-sequence energy values.

With proper inter-phase energy balancing, E_{α}=E_{β}=0 shall be ensured. However, theoretical solutions of v_{com} from (11a)-(11b) are computation-intensive and do not consider the actual energies of the system. The present method derives a closed-loop control technique based on the actual energies calculated from the SM capacitor voltages and eliminates the need for feed-forward calculations or complex inverse-mapping procedures. Moreover, the closed-loop technique considers errors committed due to parameter variation or unmodeled dynamics.

From the above references, it is clear that E_{αf}=E_{βf}=0 ensure time-averaged unbalanced energies E_{α}=E_{β}=0. Hence, E_{αf}=E_{βf}=0 are sufficient conditions for inter-phase energy balancing controllers. Thus, the incremental energies produced by common-mode voltages i.e., ΔE_{com,α} and ΔE_{com,β}, are used to control E_{α} and E_{β} (or E_{αf} and E_{βf}). The common-mode voltage reference in-phase with the respective unit currents is required to generate ΔE_{com,α} and ΔE_{com,β} as given in (11a)-(11b).

The closed-loop controller and plant model are illustrated in FIG. 5. Here, I_{gα,pk} and I_{gβ,pk} are amplitudes of i_{gα} and i_{gβ}, respectively. During an unbalanced operation, the disturbance power terms P_{gα} and P_{gβ} will have non-zero magnitudes. As no feed-forward compensation of the disturbance power terms is envisaged in the method of the embodiment, the designed loop gain of the closed-loop model should be sufficiently large such that the disturbance terms have no significant effect on the system response. Moreover, the controllers should only react to the variation of the time-averaged energies rather than the ripples present in e_{α} and e_{β}. Thus, the fundamental cycle time-averaged orthogonal energy components (E_{αf} and E_{βf}) are calculated using equations (6a) and (6b). These enable the removal of feed-forward calculations, compensations, and inverse mapping for zero-sequence voltage.

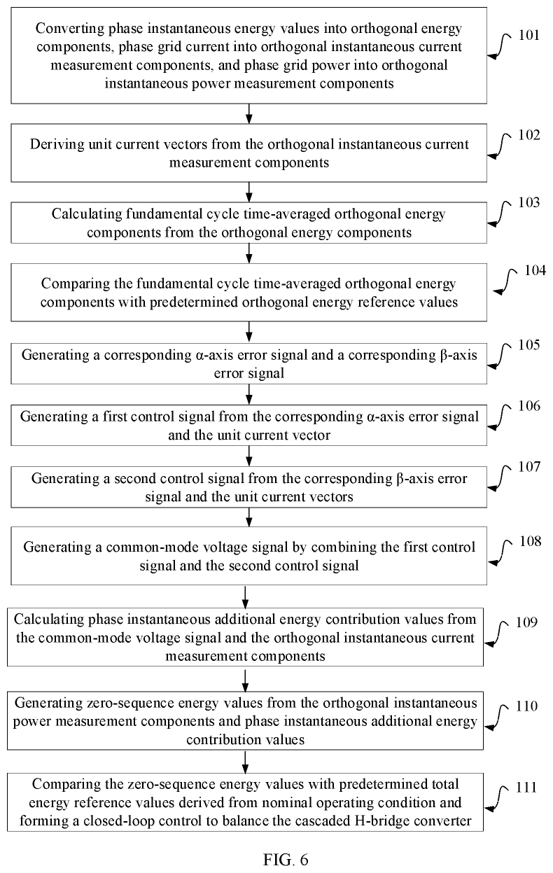

A flowchart of the method for balancing control of Y-connected cascaded H-bridge converter in accordance with an embodiment of the present disclosure is illustrated in FIG. 6. The method for energy balancing control of a three-phase cascaded H-bridge converter includes the following steps:

Step 1: converting (101) phase instantaneous energy values into orthogonal energy components, phase grid currents into orthogonal instantaneous current measurement components, and phase grid power into orthogonal instantaneous power measurement components by applying a stationary reference frame transformation.

Step 2: deriving (102) unit current vectors from the orthogonal instantaneous current measurement components.

Step 3: calculating (103) fundamental cycle time-averaged orthogonal energy components from the orthogonal energy components.

Step 4: comparing (104) the fundamental cycle time-averaged orthogonal energy components with predetermined orthogonal energy reference values, wherein the predetermined orthogonal energy reference values are classified as a α-axis orthogonal energy reference value and a β-axis orthogonal energy reference value.

Step 5: generating (105) a corresponding α-axis error signal and a corresponding β-axis error signal.

Step 6: generating (106) a first control signal from the corresponding α-axis error signal and the unit current vector.

Step 7: generating (107) a second control signal from the corresponding β-axis error signal and the unit current vectors.

Step 8: generating (108) a common-mode voltage signal by combining the first control signal and the second control signal.

Step 9: calculating (109) phase instantaneous additional energy contribution values from the common-mode voltage signal and the orthogonal instantaneous current measurement components.

Step 10: generating (110) zero-sequence energy values from the orthogonal instantaneous power measurement components and phase instantaneous additional energy contribution values.

Step 11: comparing (111) the zero-sequence energy values with predetermined total energy reference values derived from nominal operating condition and forming a closed-loop control to balance the cascaded H-bridge converter.

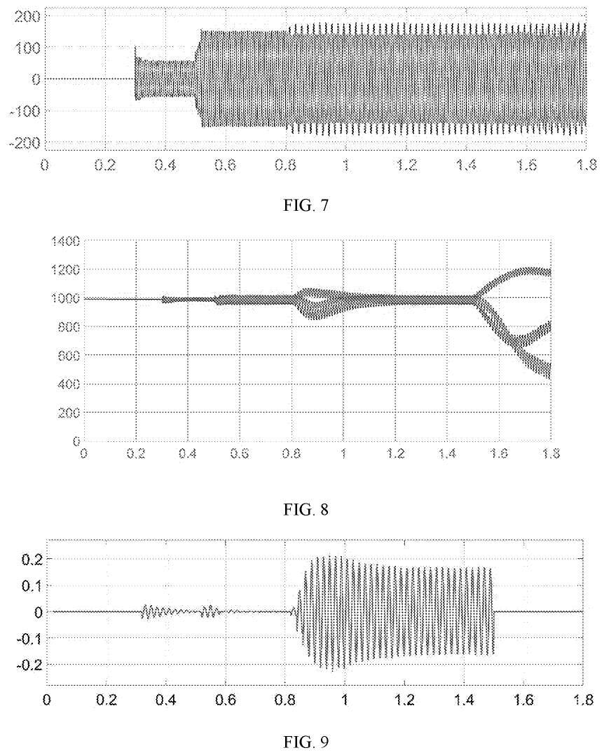

The simulation results show the operation of a typical star-connected cascaded H-bridge converter as a STATCOM. At t=0.8 sec, a 15% negative sequence current step is added to the STATCOM current. It can be seen from FIGS. 7, 8 and 9 that the SM average capacitor voltages are stable and convergent. At t=1.5 sec, the inter-phase energy balancing controllers are deactivated, resulting in a rapid divergence of capacitor voltages. This demonstrates the effectiveness of the present control method.

The graph in FIG. 7 shows the behavior of the three-phase currents under normal operating conditions and during a transient event, such as a sudden change in grid voltage or current. Initially, the three-phase currents remain stable and balanced, indicating proper operation of the STATCOM system. At a specific time point, a transient disturbance is introduced, such as a negative sequence current step, which causes an imbalance in the three-phase currents. The present control method responds to the transient disturbance by regulating the inter-phase energy imbalances and restoring the three-phase currents to their balanced state. The graph demonstrates the effectiveness of the control system in maintaining stability and convergence of the three-phase currents during both steady-state and transient conditions.

The graph in FIG. 8 shows the average SM capacitor voltages for the three phases over time under both steady-state and transient conditions. Initially, the capacitor voltages remain stable and converge to their desired values, indicating proper operation of the inter-phase energy balancing controllers. At a specific time point, a transient disturbance, such as a negative sequence current step, is introduced, causing a temporary deviation in the capacitor voltages. The present control method effectively regulates the inter-phase energy imbalances, ensuring that the capacitor voltages quickly stabilize and converge back to their desired values. At another time point, the inter-phase energy balancing controllers are deactivated, resulting in a rapid divergence of the capacitor voltages, demonstrating the critical role of the present control methodology in maintaining system stability.

The graph in FIG. 9 shows the behavior of the common-mode voltage under normal operating conditions, during a transient disturbance, and after the controllers are deactivated. Initially, the common-mode voltage remains stable and within the desired range, indicating proper operation of the inter-phase energy balancing controllers. At a specific time point, a transient disturbance, such as a negative sequence current step, is introduced, causing a temporary fluctuation in the common-mode voltage. The present control method responds to the disturbance by adjusting the common-mode voltage to restore energy balance among the phases. The graph demonstrates the system's ability to maintain stability and convergence of the common-mode voltage during transient conditions. At another time point, the inter-phase energy balancing controllers are deactivated, resulting in a rapid divergence of the common-mode voltage, highlighting the importance of the present control methodology in maintaining system stability.

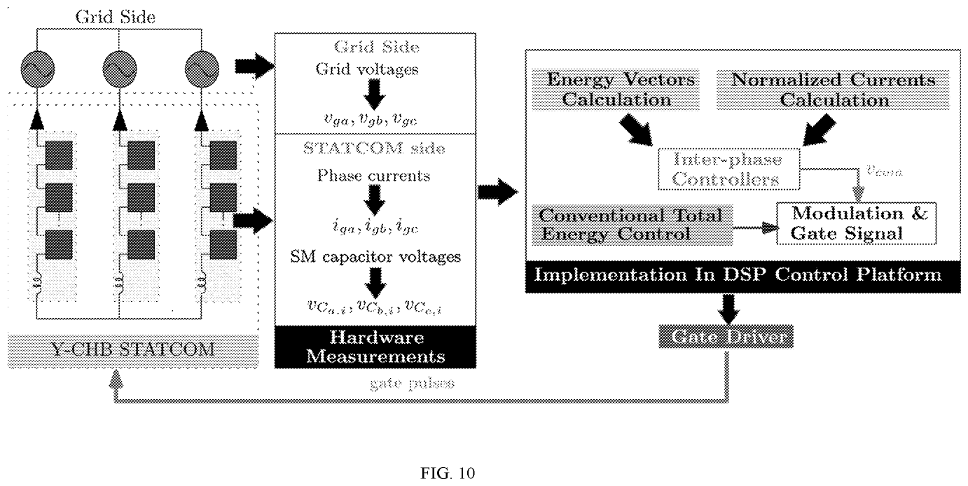

In another aspect, one embodiment of the present disclosure provides a system for α-β stationary reference frame-based decoupled energy balancing control of a cascaded H-bridge converter with direct zero-sequence voltage generation. In an embodiment, the cascaded H-bridge converter is a Y-connected/star-connected cascaded H-bridge converter. A system level architecture for decoupled energy balancing control of Y-connected cascaded H-bridge converter in accordance with an embodiment of the present disclosure is illustrated in FIG. 10.

The system for α-β stationary reference frame-based decoupled energy balancing control of a cascaded H-bridge converter includes a memory and a processor. The memory can be a separate physical unit and can be connected to the processor via a bus. In an embodiment, the system includes a memory configured to store executable control instructions and a processor operably coupled to the three-phase Y-connected cascaded H bridge converter. The processor is configured, upon execution of the control instructions, to receive measured phase currents, grid voltages, and sub module capacitor voltages of the three-phase Y-connected cascaded H bridge converter; and perform the energy balancing control. The energy balancing control may be implemented through modification of control software executed by the processor without requiring additional hardware components.

The memory is used for storing program instructions, and the processor calls the program instructions to execute the technical solution of any one of the above method embodiments. The memory can include a volatile memory, such as a random-access memory (RAM); the memory can also include a non-volatile memory, such as a flash memory, a hard disk drive (HDD) or a solid-state drive (SSD); the memory can also include a combination of the above kinds of memories.

The processor can be a Central Processing Unit (CPU), a Network Processor (NP), or a combination of the CPU and the NP. The processor can further include a hardware chip. The above hardware chip can be an application-specific integrated circuit (ASIC), a programmable logic device (PLD), or a combination thereof. The above PLD can be a complex programmable logic device (CPLD), a field-programmable gate array (FPGA), a generic array logic (GAL), or any combination thereof.

The embodiments of the present disclosure may achieve at least one of:
Decoupling can be performed at the individual phase energy level.
Three controllers are used to balance three-phase energies.
Does not require computation-intensive extraction of symmetrical positive and negative sequence voltage and/or current components.
Independent from PLL angle information, which results in improved reliability, especially during steep grid voltage transients.
There may be no complicated controller feed-forward calculation performed.
The zero-sequence voltage is directly generated using the instantaneous values of the currents and eliminates the burden of inverse-mapping. Thus, complex inverse-mapping calculations are eliminated.
Controller actions are performed on the actual phase energies (or capacitor voltages) instead of taking the model predictive approach.
There may be a direct generation of common-mode voltages from the per-unit current vectors in the decoupled α-β domain without any complicated feed-forward calculation or calculation-intensive reference frame inverse mapping procedure.
Three-decoupled energy vector-based controller design is performed and the α-β reference frames are used for present inter-phase energy balancing, and zero-sequence energy is used for total energy balancing in the conventional way.

The foregoing description of the present disclosure has been set merely to illustrate the disclosure and is not intended to be limited. Since modifications of the disclosed embodiments incorporating the substance of the disclosure may occur to person skilled in the art, the disclosure should be construed to include everything within the scope of the disclosure.

What is claimed is:

1. A method for energy balancing control of a three-phase Y-connected cascaded H-bridge converter, the method comprising:
converting phase instantaneous energy values into orthogonal energy components, phase grid currents into orthogonal instantaneous current measurement components, and phase grid power into orthogonal instantaneous power measurement components by applying an α-β stationary reference frame transformation;
deriving unit current vectors from the orthogonal instantaneous current measurement components;
calculating fundamental cycle time-averaged orthogonal energy components from the orthogonal energy components;
comparing the fundamental cycle time-averaged orthogonal energy components with predetermined orthogonal energy reference values, wherein the predetermined orthogonal energy reference values are classified as an α-axis orthogonal energy reference value and a β-axis orthogonal energy reference value;
generating a corresponding α-axis error signal and a corresponding β-axis error signal;
generating a first control signal from the corresponding α-axis error signal and the unit current vector;
generating a second control signal from the corresponding β-axis error signal and the unit current vectors; and
generating a common-mode voltage signal by combining the first control signal and the second control signal.

2. The method according to claim 1, wherein the method further comprises:
calculating phase instantaneous additional energy contribution values from the common-mode voltage signals and the orthogonal instantaneous current measurement components;
generating zero-sequence energy values from the orthogonal instantaneous power measurement components and phase instantaneous additional energy contribution values; and
comparing the zero-sequence energy values with predetermined total energy reference values derived from nominal operating condition and forming a closed-loop control to balance the cascaded H-bridge converter.

3. The method according to claim 2, wherein, during calculating phase instantaneous additional energy contribution values, phase instantaneous additional energy contribution values are represented as:
$$Δ {E}_{com , α} = {\int }_{0}^{T} {v}_{c o m} {i}_{g α} dt ;$$
$$Δ {E}_{c o m , β} = {\int }_{0}^{T} {v}_{c o m} {i}_{g β} d t ,$$
wherein (ΔE_{com,α}, ΔE_{com,β}) represents the phase instantaneous additional energy contribution values, (v_{com}) represents the common-mode voltage signal and (i_{gα}, i_{gβ}) represents the orthogonal instantaneous current measurement components.

4. The method according to claim 2, wherein, during generating the zero-sequence energy values, the zero-sequence energy values are represented as:
$${E}_{α} = {\int }_{0}^{T} {p}_{g α} d t + {\int }_{0}^{T} {v}_{c o m} {i}_{g α} d t = {\int }_{0}^{T} {p}_{g α} d t + Δ {E}_{c om , α} ;$$
$${E}_{β} = {\int }_{0}^{T} {p}_{g β} d t + {\int }_{0}^{T} {v}_{c o m} {i}_{g β} d t = {\int }_{0}^{T} {p}_{g β} d t + Δ {E}_{c o m , β} ,$$
where (E_{α}, E_{β}) represents the zero-sequence energy values, (p_{gα}, p_{gβ}) represents the orthogonal instantaneous power measurement components, (ΔE_{com,α}, ΔE_{com,β}) represents the phase instantaneous additional energy contribution values, (v_{com}) represents the common-mode voltage signal and (i_{gα}, i_{gβ}) represents the orthogonal instantaneous current measurement components.

5. The method according to claim 1, wherein the α-axis orthogonal energy reference value and the β-axis orthogonal energy reference value are set to zero to eliminate inter phase energy imbalance.

6. The method according to claim 1, wherein, during converting the phase instantaneous energy values into the orthogonal energy components by applying the stationary reference frame transformation, the orthogonal energy components are represented as:
$$[ \begin{matrix}{e}_{α} \\ {e}_{β} \\ {e}_{0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{e}_{a} \\ {e}_{b} \\ {e}_{c}\end{matrix} ]$$
wherein (eₐ, e_{b}, e_{c}) represents the phase instantaneous energy values and (e_{α}, e_{β}, e₀) represents the orthogonal energy components.

7. The method according to claim 1, wherein, during converting the phase grid power into the orthogonal instantaneous power measurement components by applying the stationary reference frame transformation, the orthogonal instantaneous power measurement components are represented as:
$$[ \begin{matrix}{p}_{g α} \\ {p}_{g β} \\ {p}_{g 0}\end{matrix} ] = [ \begin{matrix}\frac{2}{3} & - \frac{1}{3} & - \frac{1}{3} \\ 0 & \frac{1}{\sqrt{3}} & - \frac{1}{\sqrt{3}} \\ \frac{1}{3} & \frac{1}{3} & \frac{1}{3}\end{matrix} ] [ \begin{matrix}{p}_{ga} \\ {p}_{g b} \\ {p}_{gc}\end{matrix} ] = [ \begin{matrix}\frac{2}{3} {v}_{ga} {i}_{ga} - \frac{1}{3} {v}_{gb} {i}_{gb} - \frac{1}{3} {v}_{gc} {i}_{gc} \\ \frac{1}{\sqrt{3}} {v}_{gb} {i}_{gb} - \frac{1}{\sqrt{3}} {v}_{gc} {i}_{gc} \\ \frac{1}{3} {v}_{ga} {i}_{ga} + \frac{1}{3} {v}_{gb} {i}_{gb} + \frac{1}{3} {v}_{gc} {i}_{gc}\end{matrix} ] = [ \begin{matrix}\frac{1}{2} ( {v}_{g α} {i}_{g α} - {v}_{g β} {i}_{g β} ) \\ - \frac{1}{2} ( {v}_{g α} {i}_{g β} + {v}_{g β} {i}_{g α} ) \\ \frac{1}{2} ( {v}_{g α} {i}_{g α} + {v}_{g β} {i}_{g β} )\end{matrix} ] ,$$
wherein (p_{gα}, p_{gβ}, p_{g0}) represents the orthogonal instantaneous power measurement components, (p_{gj}) represents phase grid power, (v_{gj}) represents phase grid voltage, (i_{gj}) represents phase grid current, wherein ∀j∈{a, b, c}, (v_{gα}, v_{gβ}) represents the orthogonal instantaneous voltage measurement components, and (i_{gα}, i_{gβ}) represents the orthogonal instantaneous current measurement components.

8. The method according to claim 1, wherein the stationary reference frame transformation is Clarke Transformation.

9. The method according to claim 1, wherein the unit current vectors are derived by normalizing the orthogonal instantaneous current measurement components.

10. The method according to claim 1, wherein, during calculating the fundamental cycle time-averaged orthogonal energy components from the orthogonal energy components, the fundamental cycle time-averaged orthogonal energy components are represented as:
$${E}_{α f} = \frac{1}{T} {\int }_{0}^{T} {e}_{α} dt ;$$
$${E}_{β f} = \frac{1}{T} {\int }_{0}^{T} {e}_{β} d t ,$$
wherein (E_{αf}, E_{βf}) represents the fundamental cycle time-averaged orthogonal energy components and (e_{α}, e_{β}, e₀) represents the orthogonal energy components.

11. The method according to claim 1, wherein, during generating the first control signal, the first control signal is generated by processing the corresponding α-axis error signal and the unit current vector through closed-loop proportional-integral (PI) controllers and represented as:
v_{com,α}=k_{α}\hat{ι}_{gα}, wherein (v_{com,α}) represents the first control signal, (k_{α}) represents the closed-loop proportional-integral (PI) controller output derived from the corresponding α-axis error signal, (\hat{ι}_{gα}) represents the unit current vector corresponding to α-axis.

12. The method according to claim 11, wherein the closed-loop proportional-integral (PI) controller output (k_{α}) derived from the corresponding α-axis error signal is represented as:
$${k}_{α} = {K}_{p} ( {E}_{α}^{*} - {E}_{α} ) + {K}_{i} {\int }_{0}^{T} ( {E}_{α}^{*} - {E}_{α} ) d t ,$$
wherein (E_{α}) represents a zero-sequence energy value and
$$( {E}_{α}^{*} )$$
represents the α-axis orthogonal energy reference value.

13. The method according to claim 1, wherein, during generating the second control signal, the second control signal is generated by processing the corresponding β-axis error signal and the unit current vector through closed-loop proportional-integral (PI) controllers and represented as:
v_{com,β}=k_{β}\hat{ι}_{gβ},
wherein (v_{com,β}) represents the second control signal, (k_{β}) represents the controller output derived from the corresponding β-axis error signal, and (\hat{ι}_{gβ}) represents the unit current vector corresponding to β-axis.

14. The method according to claim 13, wherein the closed-loop proportional-integral (PI) controller output (k_{β}) derived from the corresponding β-axis error signal is represented as:
$${k}_{β} = {K}_{p} ( {E}_{β}^{*} - {E}_{β} ) + {K}_{i} {\int }_{0}^{T} ( {E}_{β}^{*} - {E}_{β} ) d t ,$$
wherein (E_{β}) represents a zero-sequence energy value and
$$( {E}_{β}^{*} )$$
represents the β axis orthogonal energy reference value.

15. A system for energy balancing control of a three-phase Y-connected cascaded H-bridge converter, the system comprising:
a memory storing executable control instructions; and
a processor operably coupled to the three-phase Y-connected cascaded H bridge converter and configured, upon execution of the control instructions, to:
receive measured phase currents, grid voltages, and sub module capacitor voltages of the three-phase Y-connected cascaded H bridge converter; and
perform energy balancing control by executing the method according to claim 1, wherein the energy balancing control is implemented through modification of control software executed by the processor without requiring additional hardware components.
